(19) United States
(12) Patent Application Publication
(10) Pub. No.: US 2012/0086557 A1
(43) Pub. Date: Apr. 12, 2012

(54) WIRELESS TERMINAL AND INFORMATION STORAGE METHOD

(75) Inventor: Yasuaki Inatomi, Kanagawa (JP)

(73) Assignee: PANASONIC CORPORATION, Osaka (JP)

(21) Appl. No.: 13/377,256

(22) PCT Filed: May 7, 2010
(86) PCT No.: PCT/JP2010/003142

§ 371 Date: Dec. 9, 2011

(30) Foreign Application Priority Data
Jul. 3, 2009 (JP) 2009-158697

(51) Int. Cl. H04Q 5/22

(52) U.S. Cl. 340/10.3

(57) ABSTRACT

A wireless terminal is provided that can ensure security while gathering a communication history using little memory. The wireless terminal (200) has a secure ID generation unit (221) for generating a secure ID that includes a terminal ID, and a transmission unit (224) for broadcasting the secure ID generated by the secure ID generation unit (221). The secure ID generation unit (221) writes a different terminal ID for each transmission on a first portion of the secure ID, and, on a second portion of the secure ID, writes the terminal ID that had been written on the first portion of the secure ID transmitted immediately before as a link ID.

### TECHNICAL FIELD

The present invention relates to a radio terminal that performs transmission or reception of ID information to/from another radio terminal, and an information recording method used by this radio terminal.

### BACKGROUND ART

A radio tag (RFID: radio frequency identification) is an IC (integrated circuit) chip that performs close-range radio communication and information processing. Radio tags are expected to be used in a variety of fields due to their small size and power-saving design. For example, radio tags could be used in a so-called child monitoring service for confirming that a child is on the way home from school or ascertaining a child's route when returning home from school.

In this example, radio base stations (hereinafter referred to simply as “base stations”) are set up at a school gate and along a route to the school. Then each base station collects radio tag ID (identifier) information from a radio tag embedded in a schoolbag or similar item carried by each child. By this means, it is possible to collect information regarding which radio tag passed through which base station radio communication area (hereinafter referred to as “base station area”) at what time. Confirmation that a child has passed through the school gate and estimation of a child's route and position can then be performed based on the collected data.

However, since a base station needs to secure a power supply and to be connected to a network, possible installation locations are limited. Therefore, it may not be possible to set up base stations at a sufficient number of locations, and there may be a long interval (segment) between base stations. In such a case, a child's movements can only be roughly estimated.

One possibility is for each radio tag to acquire and store a communication history outside a base station area. Here, a communication history is assumed to be information regarding which other radio tag has been approached to within communication distance (hereinafter referred to simply as “approached,” and by other terms such as “close” or “nearby”), and when this occurred.

FIG. 1 is a drawing showing an overview of a child monitoring system that performs communication history storage. As shown in FIG. 1, it is assumed that, for example, a certain child 10 passes through the base station area of base station 20 installed near his home, walks along the school route together with another child 30 met on the way, and passes through the base station area of base station 40 installed at the school gate.

Radio tags (not shown) carried by children 10 and 30 respectively periodically broadcast their own ID information in the surrounding area. When the radio tags carried by children 10 and 30 are close to each other, the ID information of each is received by the other. Each radio tag records ID information received from the other, and the reception time, in an internal recording medium as communication history 11 and communication history 31 respectively. Then, when child 10 enters the base station area of base station 40, for example, the radio tag carried by child 10 transmits ID information of that radio tag, and communication history 11 recorded outside a base station area, to base station 40.

This communication history 11 is information indicating from about what time child 10 and child 30 were together. Service provision center 50 analyzes the movements of child 10 based on ID information and communication history 11 received by base stations 20 and 40, and reports the analysis results to, for example, a school teacher or guardian.

This kind of system can collect information regarding which radio tag and which other radio tag came close to each other at what time and in which segment outside a base station area. Therefore, it is possible to estimate a child's movements in greater detail.

However, a problem with the above system is that it is difficult to ensure security. This is because there is a possibility of a malevolent third party identifying a radio tag that continually transmits the same ID information, and tracing the movements of a specific user.

Thus, a technology that changes ID information momentarily has been described in Patent Literature 1, for example. According to this technology, a third party can be prevented from tracing a radio tag based on the sameness (identity) of ID information.

### CITATION LIST

### Patent Literature

PTL 1
WO 2005/031579

### SUMMARY OF INVENTION

### Technical Problem

However, with the technology described in Patent Literature 1, each time ID information is received, it must be stored in memory as a communication history. Consequently, if there is a long interval (segment) between base stations, there is a risk of a communication history overflowing and valid communication history collection no longer being able to be performed. It is normally difficult to install large memory in a radio tag. Therefore, a radio tag is desirable that can collect a communication history while preventing tracing using little memory.

It is therefore an object of the present invention to provide a radio terminal and information recording method that can ensure security while collecting a communication history using little memory.

### Solution to Problem

A radio terminal of the present invention has a secure ID generation section that generates a secure ID that includes a terminal ID, and a transmission section that broadcasts the secure ID generated by the secure ID generation section; wherein the secure ID generation section writes a terminal ID that differs for each transmission in a first part of the secure ID, and in a second part of the secure ID, writes the terminal ID that was written in the first part of the secure ID transmitted immediately before as a link ID.

A radio terminal of the present invention has: a reception section that receives from another radio terminal a secure ID generated by that radio terminal; a history information storage section that records history information that is a reception history of the secure ID received by the reception section; a compression processing section that, when a terminal ID written in a first part of a certain secure ID received by the reception section and a link ID written in a second part of another secure ID received by the reception section match, determines that the transmission source of those two secure IDs is the same, and compresses and re-records in the history information storage section the history information of a plurality of the secure IDs whose transmission source has been determined to be the same; and a base station communication section that transmits the history information recorded in the history information storage section to a base station.

An information recording method of the present invention has: a step of receiving from another radio terminal a secure ID generated by that radio terminal; a step of recording history information that is a reception history of a received secure ID in a history information storage section; a step of, when a terminal ID written in a first part of a certain received secure ID and a link ID written in a second part of another received secure ID match, determining that the transmission source of those two secure IDs is the same; and a step of compressing and re-recording in the history information storage section the history information of a plurality of the secure IDs whose transmission source has been determined to be the same.

### Advantageous Effects of Invention

According to the present invention, compound information including identification information is transmitted strung together while having variability, and therefore identification information can be broadcast in a state in which it is difficult to trace. Therefore, the present invention can ensure security while collecting a communication history using little memory

### BRIEF DESCRIPTION OF DRAWINGS

FIG. 1 is a drawing showing an overview of a system that performs communication history storage using conventional radio terminals;

FIG. 2 is a system configuration diagram showing an example of the configuration of an information collection system that includes radio terminals according to an embodiment of the present invention;

FIG. 3 is a block diagram showing an example of the configuration of a radio terminal according to this embodiment;

FIG. 4 is a flowchart showing operation relating to recording of history data of a radio terminal according to this embodiment;

FIG. 5 is a drawing showing schematically the nature of communication between radio terminals according to this embodiment;

FIG. 6 is a drawing showing an example of the configuration of a time slot management table in this embodiment;

FIG. 7 is a flowchart showing transmission mode operation of a radio terminal according to this embodiment;

FIG. 8 is a drawing showing schematically processing of a terminal ID generation section in this embodiment;

FIG. 9 is a drawing showing a first example of the configuration of a terminal ID in this embodiment;

FIG. 10 is a drawing showing a second example of the configuration of a terminal ID in this embodiment;

FIG. 11 is a drawing showing a third example of the configuration of a terminal ID in this embodiment;

FIG. 12 is a drawing showing a first example of the configuration of a secure ID in this embodiment;

FIG. 13 is a drawing showing a second example of the configuration of a secure ID in this embodiment;

FIG. 14 is a drawing showing an example of the data structure of a packet in this embodiment;

FIG. 15 is a flowchart showing reception mode operation of a radio terminal according to this embodiment;

FIG. 16 is a drawing showing a first example of a series of history data in this embodiment;

FIG. 17 is a drawing showing a second example of a series of history data in this embodiment;

FIG. 18 is a flowchart showing recording medium management processing of a radio terminal according to this embodiment;

FIG. 19 is a drawing showing an example of the way in which history data is compressed in this embodiment;

FIG. 20 is a first drawing showing the possibility of compressing history data and the possibility of ensuring security when ID information does not change;

FIG. 21 is a second drawing showing the possibility of compressing history data and the possibility of ensuring security when ID information does not change;

FIG. 22 is a first drawing showing the possibility of compressing history data and the possibility of ensuring security when ID information changes randomly;

FIG. 23 is a second drawing showing the possibility of compressing history data and the possibility of ensuring security when ID information changes randomly;

FIG. 24 is a first drawing showing the possibility of compressing history data and the possibility of ensuring security in this embodiment;

FIG. 25 is a second drawing showing the possibility of compressing history data and the possibility of ensuring security in this embodiment;

FIG. 26 is a flowchart showing operation relating to transmission of a communication history of a radio terminal according to this embodiment;

FIG. 27 is a drawing showing an overview of a server configuration and processing for a communication history in this embodiment;

FIG. 28 is a drawing showing a first example of another compression method for history data in this embodiment;

FIG. 29 is a drawing showing a second example of another compression method for history data in this embodiment; and

FIG. 30 is a drawing showing a third example of another compression method for history data in this embodiment.

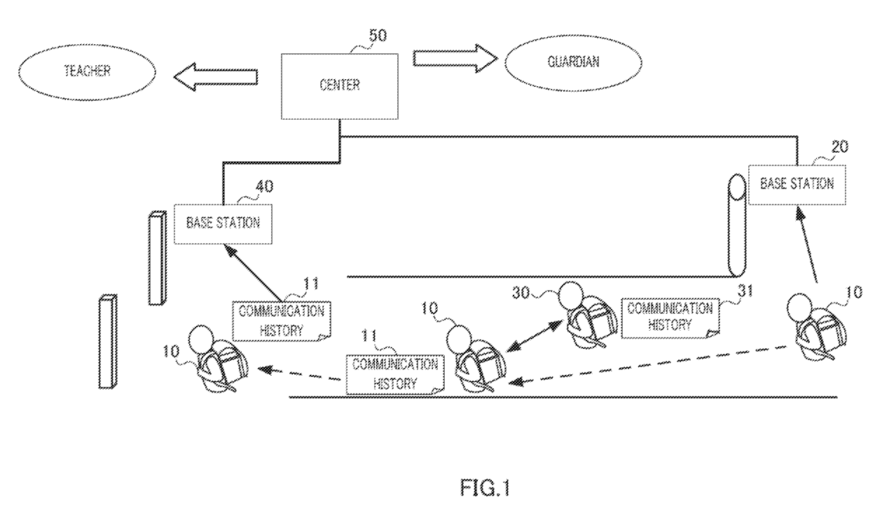

### DESCRIPTION OF EMBODIMENT

Now, an embodiment of the present invention will be described in detail with reference to the accompanying drawings.

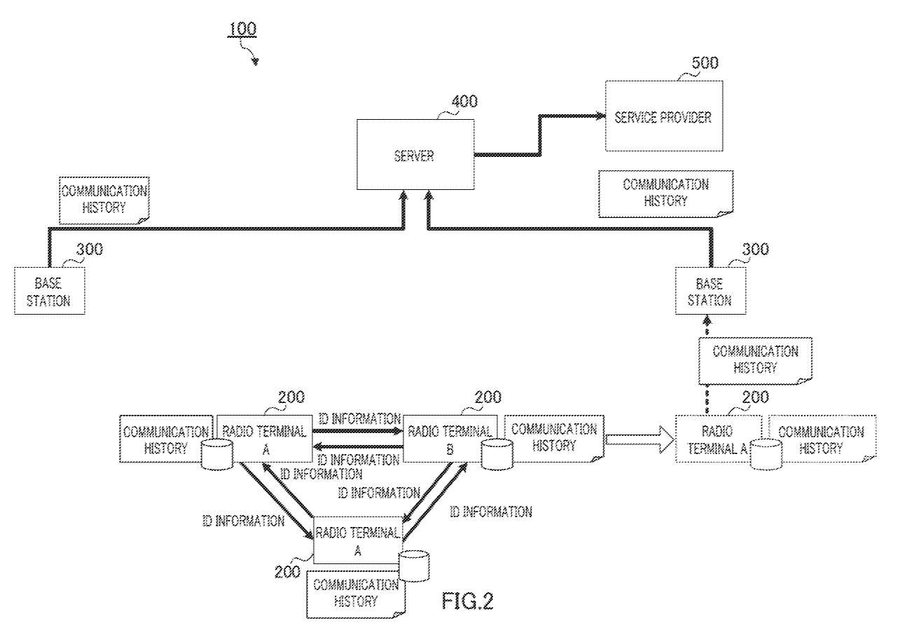

FIG. 2 is a system configuration diagram showing an example of the configuration of an information collection system that includes radio terminals according to an embodiment of the present invention.

In FIG. 2, information collection system 100 has a plurality of radio terminals 200, a plurality of base stations 300, history collection center server (hereinafter referred to simply as “server”) 400, and service provider facility 500. Base stations 300 are connected to server 400, and server 400 is connected to service provider facility 500.

Radio terminals 200 are radio tags that are each assigned a unique fixed terminal ID. Radio terminal 200 cannot only perform radio transmission of information to base station 300, but also perform radio communication with another radio terminal 200. Radio terminal 200 exchanges ID information with another radio terminal 200 present in its own communication area. Below, a state in which another radio terminal 200 has entered the communication area of a certain radio terminal 200 is referred to as “approaching,” “close to,” or “nearby.” Outside the base station areas of base stations 300, at least, radio terminal 200 stores history data, combining received ID information of another radio terminal 200 and the reception time, in an internal recording medium. As shown in FIG. 2, when having moved to the base station area of any base station 300, radio terminal 200 transmits a communication history that includes history data and its own fixed terminal ID to base station 300 by means of radio communication.

Radio terminal 200 generates different ID information each time. Specifically, this ID information differs for each transmission, and has a predetermined relationship to ID information transmitted immediately before. Radio terminal 200 determines whether or not a received plurality of ID information has the same transmission source based on this relationship, and compresses and stores history data relating to a plurality of ID information determined to have the same transmission source. Details of ID information and history data will be given later herein.

Base station 300 receives a communication history from radio terminal 200 present in its base station area. Then base station 300 transmits (uploads) the received communication history to server 400.

Based on communication histories received from base stations 300, server 400 generates a movement history of each radio terminal 200. Then server 400 transmits generated movement histories to service provider facility 500.

Based on movement histories of radio terminals 200 received from server 400, service provider facility 500 performs various kinds of information processing relating to a child monitoring or suchlike service.

Information collection system 100 having this kind of configuration can collect information regarding which other radio terminal 200 each radio terminal 200 has approached in which segment. Therefore, information collection system 100 can estimate the movements of radio terminal 200 users in greater detail.

Each radio terminal 200 broadcasts ID information that differs each time, and that has a relationship only to immediately preceding ID information. Therefore, unless a third party continuously receives successively broadcast ID information, that third party cannot determine the sameness (identity) of an ID information transmission source. By this means, each radio terminal 200 can reduce the possibility of the user's movements being traced by a malevolent third party, and can ensure a high level of security.

Also, since information collection system 100 performs compression and storage on a recording medium of history data relating to a plurality of ID information whose transmission source is determined to be the same, the data size of history data can be reduced. Therefore, information collection system 100 enables recording medium capacity to be decreased, an ID information exchange interval to be shortened, and history data for a long segment to be stored without overflowing.

The configuration of radio terminal 200 will now be described.

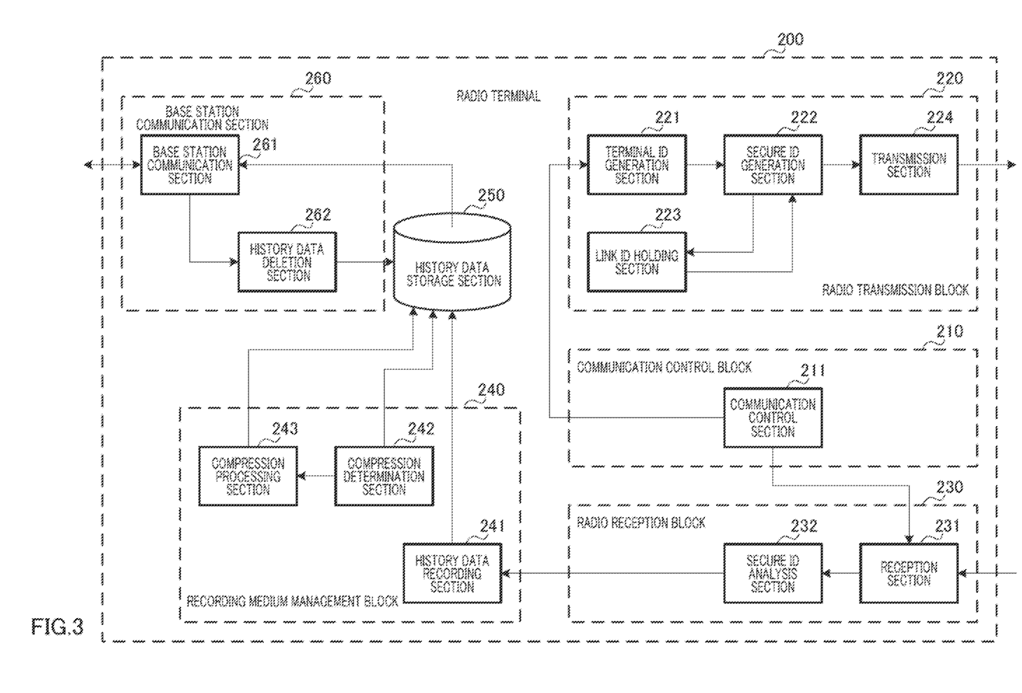

FIG. 3 is a block diagram showing an example of the configuration of radio terminal 200.

As shown in FIG. 3, radio terminal 200 is broadly divided into communication control block 210, radio transmission block 220, radio reception block 230, recording medium management block 240, history data storage section 250, and base station communication block 260. Communication control block 210, radio transmission block 220, radio reception block 230, and recording medium management block 240 are functional sections for communication with other radio terminals 200, and configure an active tag, for example. Base station communication block 260 is a functional section for communication with base stations 300, and configures a passive tag, for example. An active tag may also be configured by all of these functional sections, in which case each functional section operates independently by means of time division, operating alternately in successive time slots, for instance.

Communication control block 210 controls the operation of radio transmission block 220 and radio reception block 230 described later herein. Communication control block 210 has communication control section 211.

Communication control section 211 manages time slots, and switches between transmission mode and reception mode in time slot units. Transmission mode is a mode in which radio transmission block 220 operates, and radio terminal 200 broadcasts ID information. Reception mode is a mode in which radio reception block 230 and recording medium management block 240 operate, and radio terminal 200 receives and records ID information from another radio terminal 200. Communication control section 211 reports the current mode to radio transmission block 220 and radio reception block 230.

Each time transmission mode is reported, radio transmission block 220 repeatedly generates different ID information, and broadcasts the generated ID information. When another radio terminal 200 is present in the communication area, this ID information is received by that radio terminal 200. Radio transmission block 220 has terminal ID generation section 221, secure ID generation section 222, link ID holding section 223, and transmission section 224.

Terminal ID generation section 221 generates a terminal ID based on a fixed terminal ID assigned to radio terminal 200. A terminal ID is ID information that changes momentarily. Also, a terminal ID is data in a format that is difficult for a malevolent third party to trace, and in a format that enables server 400 to reconstitute the original fixed terminal ID. Terminal ID generation section 221 repeatedly generates a different terminal ID each time transmission mode is reported. Then terminal ID generation section 221 outputs a generated terminal ID to secure ID generation section 222.

Secure ID generation section 222 generates radio terminal 200 ID information based on an input terminal ID. ID information is data of a predetermined format that includes a first part and a second part. Secure ID generation section 222 writes the latest terminal ID in the first part, writes the latest link ID held by link ID holding section 223 described later herein in the second part, and generates secure ID information (hereinafter referred to as a “secure ID”). Then secure ID generation section 222 outputs the generated secure ID to transmission section 224. Details of a secure ID will be given later herein.

Link ID holding section 223 holds a terminal ID written in the first part of a secure ID by secure ID generation section 222 until transmission mode is next reported and a new secure ID is generated by secure ID generation section 222. In the initial state, link ID holding section 223 holds a different initial value for each radio terminal 200 that is set at the time of manufacture, for example.

Transmission section 224 broadcasts an input secure ID in the surrounding area. A secure ID transmitted by transmission section 224 is received only by another radio terminal 200 that is present in the communication area of the transmitting radio terminal.

Each time reception mode is reported, radio reception block 230 receives a secure ID from another radio terminal 200 that is nearby. Then radio reception block 230 extracts a terminal ID and link ID from a received secure ID. Radio reception block 230 has reception section 231 and secure ID analysis section 232.

Reception section 231 receives a secure ID broadcast from another radio terminal 200. Then reception section 231 outputs a received secure ID to secure ID analysis section 232.

Secure ID analysis section 232 extracts a terminal ID and link ID respectively from the first part and second part of an input secure ID. Then secure ID analysis section 232 outputs history data to recording medium management block 240. Here, history data is information combining an extracted terminal ID and link ID together with the secure ID reception time.

Recording medium management block 240 records history data input from radio reception block 230 in history data storage section 250. History data with the same transmission source is compressed by recording medium management block 240 before being recorded in history data storage section 250. Recording medium management block 240 determines whether or not a plurality of history data have the same transmission source based on the terminal ID and secure ID. Recording medium management block 240 has history data recording section 241, compression determination section 242, and compression processing section 243.

History data recording section 241 stores input history data in history data storage section 250.

Compression determination section 242 determines whether or not compression processing should be performed on history data stored in history data storage section 250. Then, if compression processing is to be performed, compression determination section 242 calls compression processing section 243. Compression determination section 242 determines that compression processing should be performed when the vacant capacity of history data storage section 250 is less than a predetermined threshold value, for example.

When called by compression determination section 242, compression processing section 243 performs compression processing on history data stored in history data storage section 250. When the terminal ID of certain history data and the link ID of other history data match, compression processing section 243 compresses these history data as history data relating to the same transmission source. Details of compression processing will be given later herein.

History data storage section 250 is a recording medium allowing rewriting of information, such as EPROM (Erasable Programmable ROM), FeRAM (Ferroelectric Random Access Memory), or the like.

Base station communication block 260 receives a predetermined signal emitted from base station 300 by broadcasting in an unspecified direction, for instance, and determines that a base station area has been entered. At this time, base station communication block 260 extracts history data stored in history data storage section 250. Then history data storage section 250 transmits the extracted history data to base station 300. Base station communication block 260 has base station communication section 261 and history data deletion section 262.

Base station communication section 261 monitors a predetermined signal broadcast periodically from each base station 300 within that base station's base station area. Upon receiving this predetermined signal, base station communication section 261 reads history data stored in history data storage section 250. Then base station communication section 261 transmits data resulting from adding the fixed terminal ID of radio terminal 200 to the read history data to base station 300 as a communication history. Then base station communication section 261 calls history data deletion section 262.

When called by base station communication section 261, history data deletion section 262 deletes all the history data stored in history data storage section 250.

Although not shown, radio terminal 200 has, for example, a CPU (central processing unit), a storage medium such as flash memory that stores a control program, working memory such as RAM (random access memory), and an antenna. In this case, radio terminal 200 implements the functions of the above sections by execution of the control program by the CPU.

Radio terminal 200 having this kind of configuration can provide variability to ID information exchanged with other radio terminals 200, and can hold history data relating to the same communicating party in compressed form. Therefore, radio terminal 200 can upload a communication history of a long segment to server 400 while ensuring security.

The operation of radio terminal 200 will now be described.

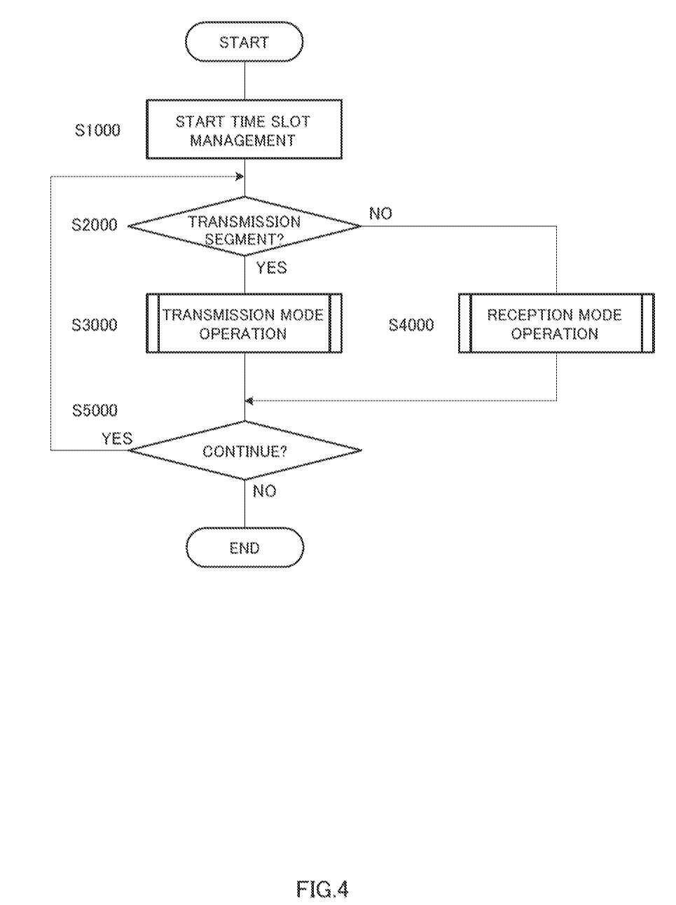

FIG. 4 is a flowchart showing radio terminal 200 operation relating to history data recording.

First, in step S1000, communication control section 211 starts time slot management based on a time slot management table.

Communication control section 211 has an internal high-precision clock (not shown), and is always in time synchronization with communication control section 211 of other radio terminals 200. Communication control section 211 also has an internal time slot management table that differs for each radio terminal 200, and implements time-division-multiplexing data communication.

Time slot management table contents differ according to which time slot is assigned to ID information broadcasting. Time slot management table setting may be performed by communication control section 211, for example. Alternatively, if provision is made for assignment of a time slot to be used for ID information broadcasting to be completed when radio terminal 200 is manufactured, time slot management table setting may be performed beforehand at the time of manufacture. In this case, a time slot management table is set in communication control section 211, for example. Alternatively, communication control section 211 may create a time slot management table randomly when radio terminal 200 is powered on. Alternatively, if radio terminal 200 performs carrier sensing before broadcasting ID information, communication control section 211 may re-create a time slot management table when another carrier is detected.

FIG. 5 is a drawing showing schematically the nature of communication between radio terminals 200. Here, a case in which there are three radio terminals 200 is illustrated.

As shown in FIG. 5, time domain t is divided into frames F1, F2 . . . , and F1, F2 . . . are each divided into first through m'th time slots S1 through Sm. For example, first through m'th time slots S1 through Sm are assigned in order to radio terminals 200A through 200C as transmission segments (intervals) of radio terminals 200A through 200C.

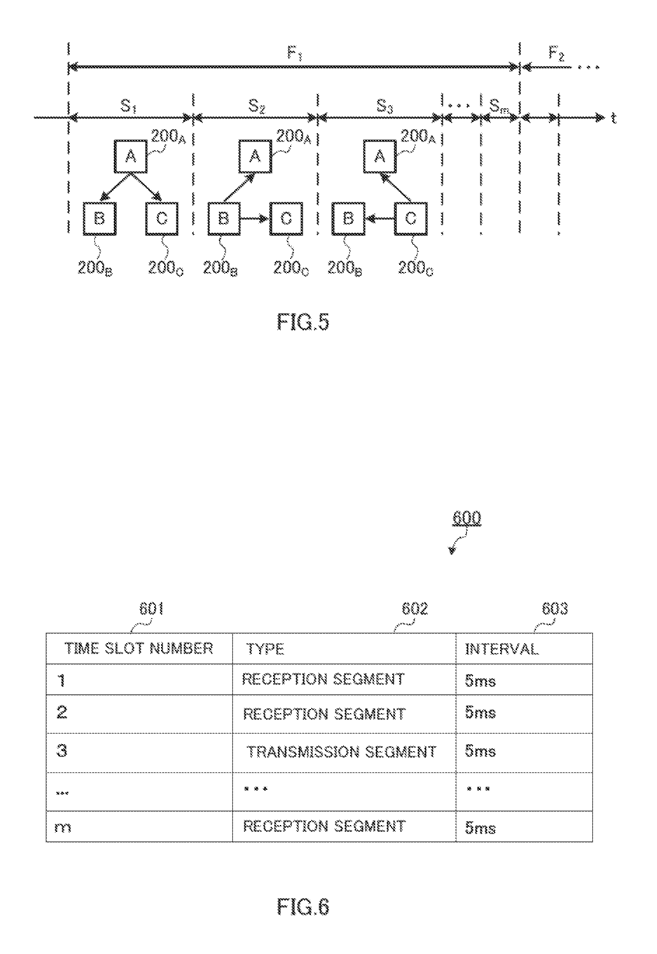

FIG. 6 is a drawing showing an example of the configuration of a time slot management table.

As shown in FIG. 6, time slot management table 600 comprises time slot number 601, type 602, and interval 603. Time slot number 601 is a number indicating the relative order of a time slot within a frame. The number of time slot numbers 601 indicates the number of time slots in a frame. Type 602 indicates whether the relevant time slot should operate in transmission mode or reception mode. “Transmission segment” indicates that the relevant time slot should operate in transmission mode, and “reception segment” indicates that the relevant time slot should operate in reception mode. Interval 603 indicates the length of the corresponding time slot (hereinafter referred to as “time slot interval”).

Communication control section 211 in FIG. 3 monitors the time slot number, and performs IC chip register setting and so forth based on the time slot management table.

In step S2000, communication control section 211 determines whether or not the current time slot is a transmission segment each time the time slot changes. Communication control section 211 performs this determination based on the current time slot number and the time slot management table. If the current time slot is a transmission segment (S2000: YES), communication control section 211 proceeds to step S3000. On the other hand, if the current time slot is not a transmission segment but a reception segment (S2000: NO), communication control section 211 proceeds to step S4000.

In step S3000, communication control section 211 starts radio terminal 200 transmission mode operation by reporting transmission mode to terminal ID generation section 221 of radio transmission block 220. Transmission mode operation will be described later herein.

On the other hand, in step S4000 communication control section 211 starts radio terminal 200 reception mode operation by reporting reception mode to reception section 231 of radio reception block 230. At this time, communication control section 211 passes the time slot interval to reception section 231. Reception mode operation will be described later herein.

When transmission mode operation or reception mode operation is completed, in step S5000 communication control section 211 determines whether or not operation relating to history data recording is to be continued. If operation relating to history data recording is to be continued (S5000: YES), communication control section 211 returns to step S2000. On the other hand, if operation relating to history data recording is not to be continued (S5000: NO), communication control section 211 terminates the series of operations.

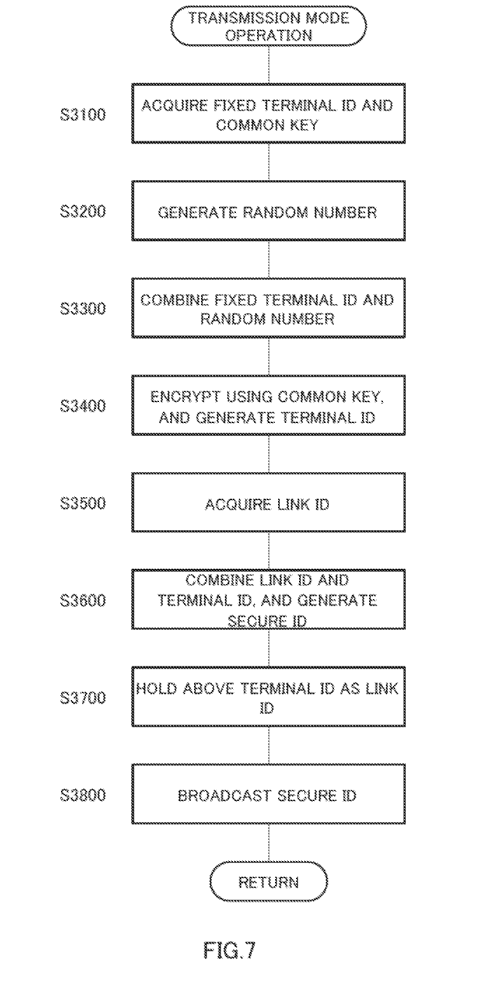

FIG. 7 is a flowchart showing radio terminal 200 transmission mode operation, corresponding to step S3000 in FIG. 4.

First, in step S3100, terminal ID generation section 221 acquires a fixed terminal ID and a common key. This common key is the same as a common key held by server 400. The fixed terminal ID and common key are stored in a radio terminal 200 storage medium beforehand at the time of manufacture, for example.

Then, in step S3200, terminal ID generation section 221 generates a random number using a known pseudo-random number generation method, for example.

Then, in step S3300, terminal ID generation section 221 generates data in which the acquired fixed terminal ID and the generated random number are combined in a separable format.

Then, in step S3400, terminal ID generation section 221 encrypts the generated data using the acquired common key, and generates a terminal ID. The common key, combining processing algorithm, and encryption processing algorithm may be made common to all radio terminals 200, and set in each radio terminal 200 at the time of manufacture. Terminal ID generation section 221 then outputs the generated terminal ID to secure ID generation section 222.

FIG. 8 is a drawing showing schematically terminal ID generation section 221 processing in steps S3100 through S3400 in FIG. 7. As described above, terminal ID generation section 221 first acquires a fixed terminal ID and generates a random number. Then, as described above, terminal ID generation section 221 uses a common key to encrypt data combining the fixed terminal ID and random number, and generates a terminal ID.

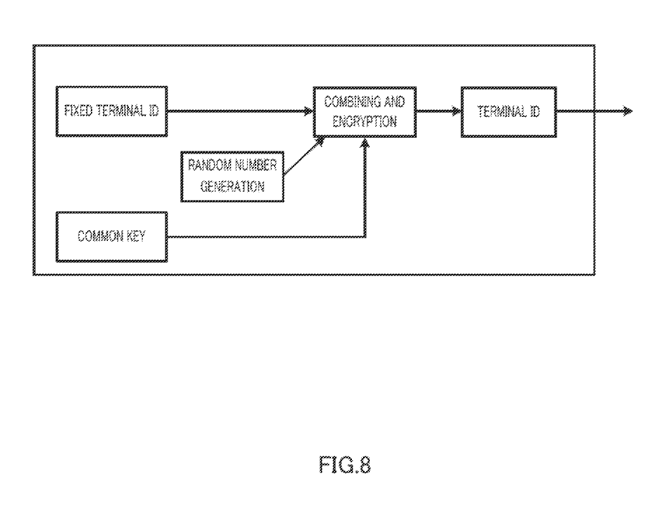

FIG. 9 through FIG. 11 are drawings showing examples of the configuration of a terminal ID.

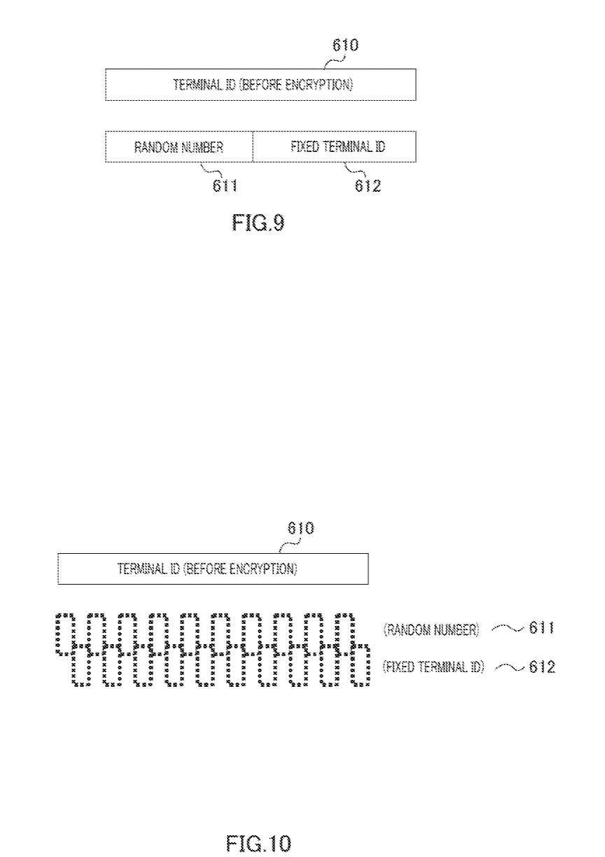

As shown in FIG. 9, terminal ID 610 can be configured by combining random number 611 and fixed terminal ID 612 aligned consecutively. Terminal ID 610 may also be configured by aligning finely divided parts of random number 611 and fixed terminal ID 612 respectively in an alternating fashion, as shown in FIG. 10.

Furthermore, terminal ID 610 can include information 613 indicating a random number incorporation pattern, as shown in FIG. 11. Here, it is assumed that a plurality of random number incorporation patterns are prepared beforehand. When a random number is incorporated using an arbitrary pattern, information 613 indicates which of the prepared plurality of random number incorporation patterns is used for incorporation. By varying the random number incorporation pattern in this way, radio terminal 200 can make it difficult for a third party to read a fixed terminal ID from a secure ID, and can further improve the security of a secure ID.

Then, in step S3500 in FIG. 7, secure ID generation section 222 acquires a link ID from link ID holding section 223.

Then, in step S3600, secure ID generation section 222 combines the acquired link ID with an input terminal ID, and generates a secure ID. That is to say, secure ID generation section 222 creates a secure ID for a newly generated terminal ID by causing the terminal ID generated the previous time to function as a link ID in a separable format. Then secure ID generation section 222 outputs the generated secure ID to transmission section 224.

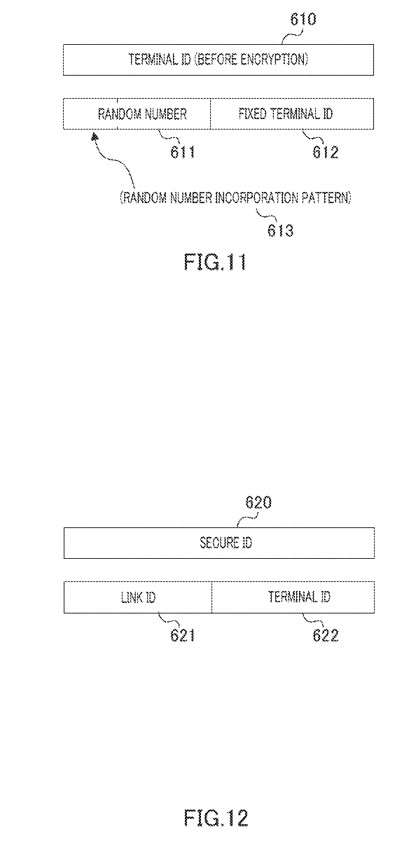

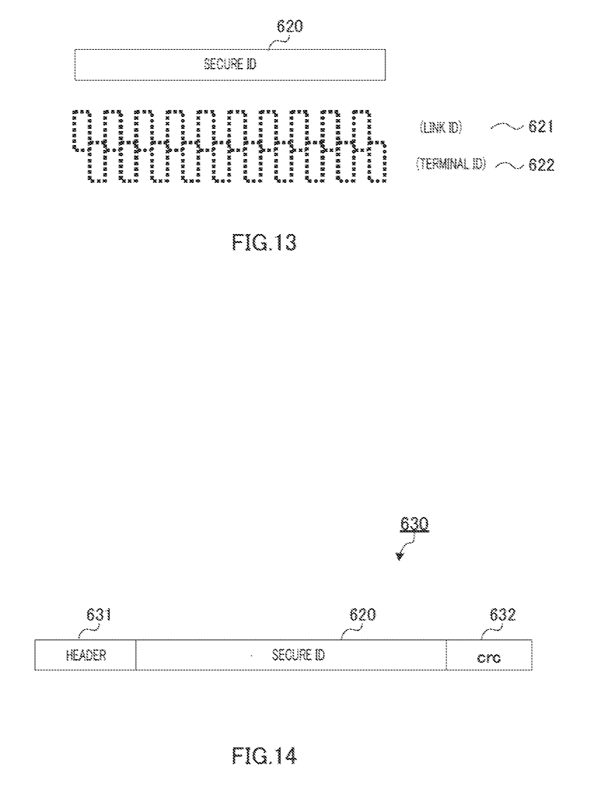

FIG. 12 and FIG. 13 are drawings showing examples of the configuration of a secure ID.

As shown in FIG. 12, secure ID 620 can be configured by combining first part 621 for writing a link ID and second part 622 for writing a terminal ID, aligned consecutively. Secure ID 620 may also be configured by aligning finely divided parts of first part 621 and second part 622 respectively in an alternating fashion, as shown in FIG. 13.

The arrangement and number of bits of first part 621 and second part 622 are determined beforehand. An algorithm for secure ID generation processing may be made common to all radio terminals 200, and set in each radio terminal 200 at the time of manufacture, for example.

As with terminal ID 610 shown in FIG. 11, secure ID 620 may also be data in a format that includes a random number and a random number incorporation pattern.

Then, in step S3700 in FIG. 7, link ID holding section 223 holds a terminal ID used for secure ID generation by secure ID generation section 222 as a link ID. At this time, link ID holding section 223 deletes an old link ID held up to that point.

Then, in step S3800, transmission section 224 broadcasts an input secure ID. At this time, transmission section 224 broadcasts the secure ID packetized in a format in accordance with a protocol for data transmission and reception between radio terminals 200. Then radio terminal 200 terminates transmission mode processing and returns to the processing in FIG. 4.

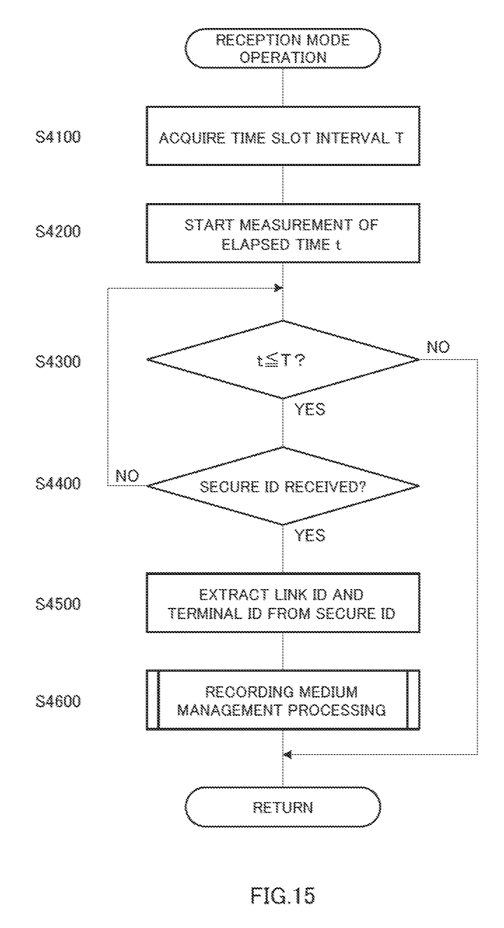

FIG. 14 is a drawing showing an example of the data structure of a packet that stores a secure ID.

As shown in FIG. 14, packet 630 comprises header 631, secure ID 620, and CRC (cyclic redundancy check) 632. In header 631 is written information indicating that this is a broadcast related packet, a sequence number that is a transmission packet serial number, information indicating that a secure ID is stored, and so forth. CRC 632 is an error detection code.

Receiving-side radio terminal 200 detects a packet 630 loss or data error occurrence based on the sequence number in header 631 and CRC 632. In the event of detecting a packet 630 loss or data error occurrence, receiving-side radio terminal 200 discards that packet 630. If it is possible in the communication method used, receiving-side radio terminal 200 may also issue a packet 630 retransmission request to the packet 630 transmission source.

FIG. 15 is a flowchart showing radio terminal 200 reception mode operation, corresponding to step S4000 in FIG. 4.

First, in step S4100, reception section 231 acquires time slot interval T from communication control section 211. If time slot interval T is fixed, provision may be made for reception section 231 to acquire time slot interval T only at the time of initial reception mode communication, and to hold that acquired time slot interval T.

Then, in step S4200, reception section 231 starts measurement of time slot elapsed tune t using a timer provided internally (not shown).

Then, in step S4300, reception section 231 determines whether or not elapsed time t is less than or equal to time slot interval T. If elapsed time t is less than or equal to time slot interval T (S4300: YES), reception section 231 proceeds to step S4400. On the other hand, if time t has reached time slot interval T (S4300: NO), reception section 231 terminates reception mode processing directly.

In step S4400, reception section 231 determines whether or not a secure ID has been received, and repeats the processing in steps S4300 and S4400 (S4400: NO) until a secure ID is received. When a secure ID is received (S4400: YES), reception section 231 outputs the received secure ID to secure ID analysis section 232, and proceeds to step S4500. More specifically, reception section 231 determines whether or not a secure ID is stored in a packet received from another nearby radio terminal 200 (see FIG. 14). Then if a secure ID is stored therein, reception section 231 extracts that secure ID.

In step S4500, secure ID analysis section 232 extracts a Link ID and terminal ID from an input secure ID (see FIG. 12 and FIG. 13). More specifically, secure ID analysis section 232 extracts information written in the above-described first part and second part as a terminal ID and link ID respectively. Assume, for example, that the secure ID generation method is to combine a link ID and terminal ID in that order. In this case, secure ID analysis section 232 extracts a link ID and terminal ID by separating the secure ID into a terminal ID corresponding to the first part and a link ID corresponding to the second part. An algorithm for secure ID analysis processing may be made common to all radio terminals 200, and set in each radio terminal 200 at the time of manufacture.

Next, in step S4600, secure ID analysis section 232 outputs history data to history data recording section 241. Here, history data comprises an extracted terminal ID and link ID, the secure ID reception time, and a time slot number. By this means, secure ID analysis section 232 causes recording medium management block 240 to execute recording medium management processing. Recording medium management processing is processing that compresses history data having the same transmission source before recording that history data in history data storage section 250. When recording medium management processing ends, radio terminal 200 terminates reception mode operation and returns to the processing in FIG. 4.

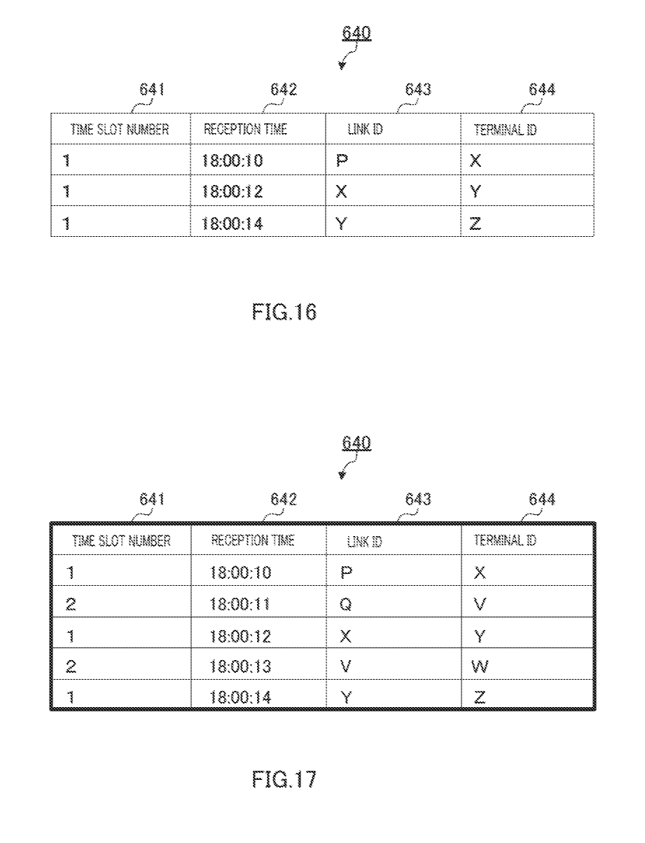

FIG. 16 is a drawing showing an example of a series of history data when only a plurality of secure IDs broadcast from the same radio terminal 200 are received.

As shown in FIG. 16, history data 640 comprises time slot number 641, secure ID reception time 642, and link ID 643 and terminal ID 644 extracted from a secure ID.

As already explained, each radio terminal 200 broadcasts a secure ID using a time slot (transmission segment) assigned to secure ID broadcasting on a frame-by-frame basis. Therefore, when a secure ID is received continually from the same radio terminal 200, time slot number 641 written in history data 640 is the same (see FIG. 16). Also, each radio terminal 200 writes information written as a terminal ID in a secure ID broadcast immediately before in the secure ID broadcast next as a link ID. Therefore, when a secure ID is received continually from the same radio terminal 200, ID information written in successive history data 640 is common to a string (see FIG. 16).

FIG. 17 is a drawing showing an example of a series of history data when a plurality of secure IDs transmitted from two radio terminals 200 are received.

The two radio terminals 200 broadcast a secure ID alternately. Therefore, as shown in FIG. 17, ID information written in successive history data 640 is not common to a string. However, when history data 640 is divided on an individual time slot number 641 basis, it is common to a string in the same way as in FIG. 16.

Therefore, radio terminal 200 can identify a series of history data 640 acquired from the same transmission source by determination of consistency between terminal ID 644 and link ID 643 for each series of history data 640 for which time slot number 641 is common. Thus, radio terminal 200 can perform collective handling of history data 640 for each transmission source even if secure IDs are received from a plurality of radio terminals 200.

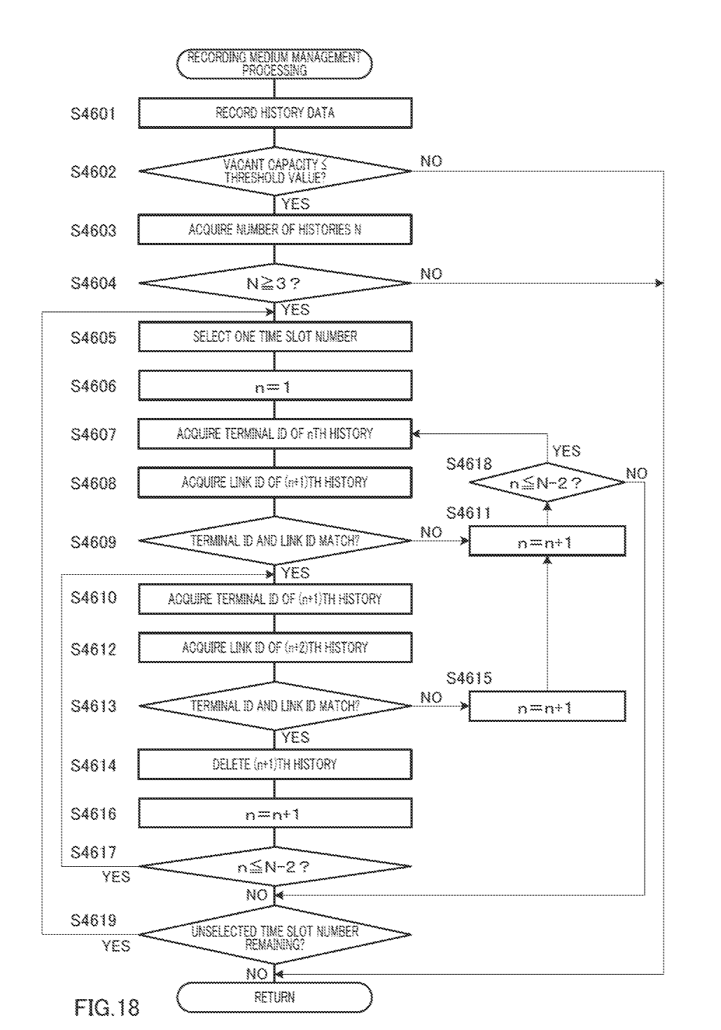

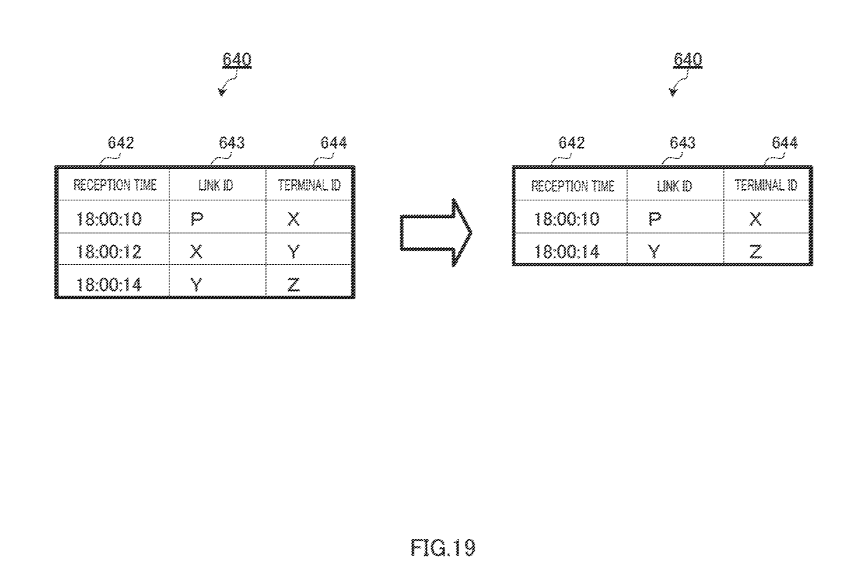

FIG. 18 is a flowchart showing radio terminal 200 recording medium management processing, corresponding to step S4600 in FIG. 15.

First, in step S4601, history data recording section 241 records input history data (see FIG. 16 and FIG. 17) in history data storage section 250.

Then, in step S4602; compression determination section 242 determines whether or not the vacant capacity of history data storage section 250 (hereinafter referred to simply as “vacant capacity”) is less than or equal to a predetermined threshold value. The predetermined threshold value is capacity necessary for storing at least one history data. If the vacant capacity exceeds the predetermined threshold value (S4602: NO), compression determination section 242 terminates recording medium management processing directly. On the other hand, if the vacant capabity is less than or equal to the predetermined threshold value (S4602: YES), compression determination section 242 proceeds to step S4603 and calls compression processing section 243.

In step S4603, compression processing section 243 references history data stored in history data storage section 250 (see FIG. 16 and FIG. 17), and acquires number of histories N. Number of histories N is the number of data per time slot number. For example, in the case of the example shown in FIG. 17, compression processing section 243 acquires number of histories N=3 for time slot number “1,” and number of histories N=2 for time slot number “2.”

In step S4604, compression processing section 243 determines whether or not there is a time slot number for which number of histories N is greater than or equal to 3. If there is a time slot number for which number of histories N is greater than or equal to 3 (S4604: YES), compression processing section 243 proceeds to step S4605. On the other hand, if there is no time slot number for which number of histories N is greater than or equal to 3 (S4604: NO), compression processing section 243 terminates recording medium management processing directly.

In step S4605, compression processing section 243 selects one time slot number for which number of histories N is greater than or equal to 3.

Then, in step S4606, compression processing section 243 sets initial value “1” for variable n. Variable n indicates the order of history data when history data for the same time slot number is arranged in a time series.

Then, in step S4607, compression processing section 243 acquires a terminal ID of nth history data from history data for the selected time slot number.

Then, in step S4608, compression processing section 243 acquires a link ID of (n+1)th history data from history data for the selected time slot number.

Then, in step S4609, compression processing section 243 determines whether or not the terminal ID acquired in step S4607 and the link ID acquired in step S4608 match. If this terminal ID and link ID match (S4609: YES), compression processing section 243 proceeds to step S4610. On the other hand, if this terminal ID and link ID do not match (S4609: NO), compression processing section 243 proceeds to step S4611.

In step S4610, compression processing section 243 acquires a terminal ID of (n+1)th history data from history data for the selected time slot number.

Then, in step S4612, compression processing section 243 acquires a link ID of (n+2)th history data from history data for the selected time slot number.

Then, in step S4613, compression processing section 243 determines whether or not the terminal ID acquired in step S4610 and the link ID acquired in step S4612 match. If the terminal ID and link ID match (S4613: YES), compression processing section 243 proceeds to step S4614. On the other hand, if the terminal ID and link ID do not match (S4613: NO), compression processing section 243 proceeds to step S4615.

In step S4614, compression processing section 243 deletes (n+1)th history data of history data for the selected time slot number from history data storage section 250. That is to say, when history data is received from the same radio terminal 200 three or more times in succession, compression processing section 243 deletes history data other than the first history data and last history data (hereinafter refereed to as “intermediate history data”). However, compression processing section 243 does not change the association of the variable n value with history data here.

Then, in step S4616, compression processing section 243 increments variable n by 1.

Then, in step S4617, compression processing section 243 determines whether or not variable n is less than or equal to N-2, and if variable n is less than or equal to N-2 (S4617: YES), compression processing section 243 returns to step S4610.

On the other hand, in step S4611 compression processing section 243 increments variable n by 1.

Then, in step S4618, compression processing section 243 determines whether or not variable n is less than or equal to N-2, and if variable n is less than or equal to N-2 (S4618: YES), returns to step S4607.

In step S4615, compression processing section 243 increments variable n by 1, and then proceeds to step S4611 and further increments variable n by 1.

That is to say, compression processing section 243 switches history data subject to deletion determination in order. Then, while there is history data subsequent to history data subject to deletion determination, and history data deletion continues to be possible, compression processing section 243 repeatedly executes the processing in steps S4610 through S4616, deleting history data.

On the other hand, if nth history data and (n+1)th history data do not form a string, compression processing section 243 does not delete the (n+1)th history data. Then compression processing section 243 restarts determination of whether or not ID information forms a string from the (n+1)th history data.

Also, even if nth history data and (n+1)th history data form a string, if (n+1)th history data and (n+2)th history data do not form a string, compression processing section 243 does not delete the (n+1)th history data and (n+2)th history data. Then compression processing section 243 restarts determination of whether or not ID information forms a string from the (n+2)th history data.

If variable n exceeds N-2 (S4617: NO or S4618: NO), compression processing section 243 proceeds to step S4619.

In step S4619, compression processing section 243 determines whether or not there is an unselected time slot number in time slot numbers for which number of histories N is greater than or equal to 3. If there is a corresponding time slot number (S4619: YES), compression processing section 243 returns to step S4605. Then compression processing section 243 selects an unselected time slot number and repeats the processing in steps S4606 through S4618. On the other hand, if there is no corresponding time slot number (S4619: NO), compression processing section 243 terminates recording medium management processing.

By means of such operation, radio terminal 200 can hold history data relating to the same communicating party in compressed form while providing variability to ID information exchanged with other radio terminals 200. Also, by performing collective compression processing when the vacant capacity of history data storage section 250 becomes less than or equal to a predetermined threshold value, the processing load can be reduced and power consumption can be suppressed.

The fact that usability of compressed history data is not lost will now be explained.

FIG. 19 is a drawing showing an example of the way in which the history data shown in FIG. 16 is compressed.

As shown in FIG. 19, compression processing section 243 deletes intermediate history data from history data in which ID information forms a string. As described later herein, server 400 in FIG. 2 can identify from individual ID information the radio terminal 200 that generated that ID information.

In movement estimation, information regarding until when which other radio terminal 200 was nearby is useful. However, in movement estimation, information regarding when individual secure IDs were received is not useful. Therefore, usability of history data is not lost even if a plurality of history data forming a string are compressed into two history data—the first and last—as shown in FIG. 19.

The usability of radio terminal 200 according to this embodiment will now be described.

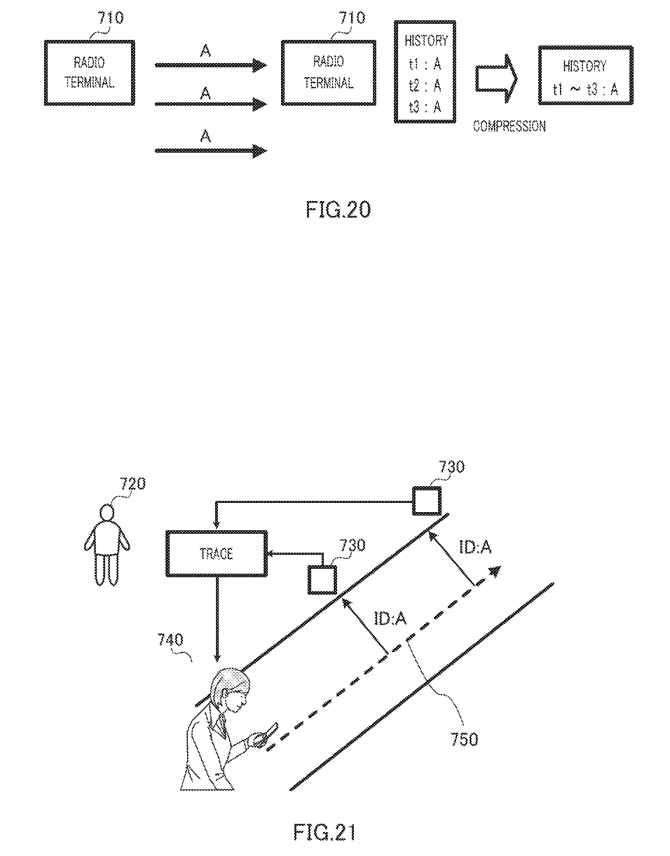

FIG. 20 and FIG. 21 are drawings showing the possibility of compressing history data and the possibility of ensuring security when ID information does not change.

As shown in FIG. 20, if transmitting-side radio terminal 710 continually broadcasts unchanging ID information, receiving-side radio terminal 710 can easily determine that a plurality of history data correspond to the same transmission source, and can compress these. On the other hand, as shown in FIG. 21, malevolent third party 720 can also trace an ID information transmission source using ID information receiver 730, and can easily ascertain route 750 of user 740.

That is to say, in a communication system in which ID information does not change, compressed recording of history data can be performed, but it is difficult to ensure the security of ID information.

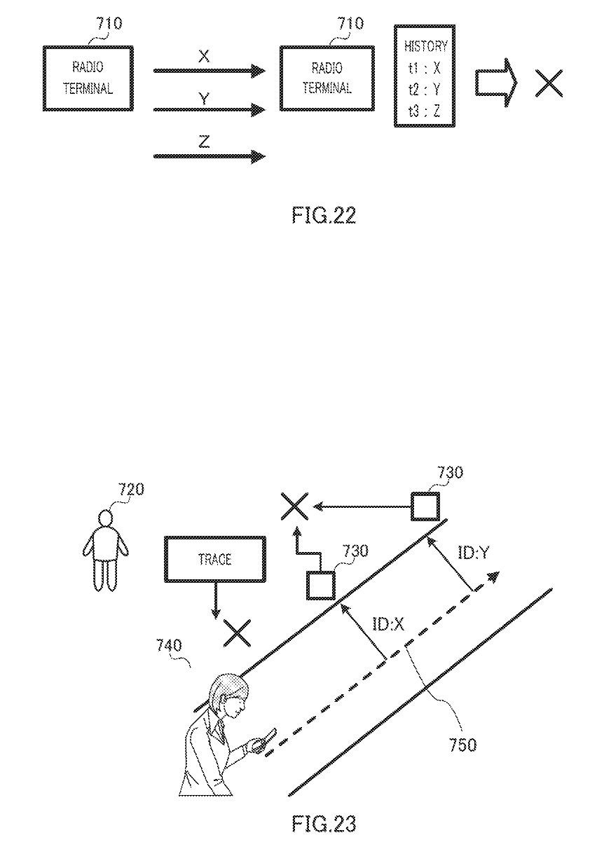

FIG. 22 and FIG. 23 are drawings showing the possibility of compressing history data and the possibility of ensuring security when ID information changes randomly. Such ID information can be generated using a hash chain method, for example.

As shown in FIG. 22, if transmitting-side radio terminal 710 continually broadcasts ID information in which ID information changes randomly, receiving-side radio terminal 710 cannot easily determine that a plurality of history data correspond to the same transmission source. For example, with a hash chain method, the processing load for determination processing is heavy, and therefore it is difficult for transmission source sameness (identity) to be determined by a small radio terminal such as a radio tag. Therefore, even if history data correspond to the same transmission source, receiving-side radio terminal 710 cannot compress these. On the other hand, as shown in FIG. 23, it is also difficult for malevolent third party 720 to trace an ID information transmission source since ID information differs each time.

That is to say, in a communication system in which ID information changes but does not form a string, the security of ID information can be ensured, but compressed recording of history data cannot be performed.

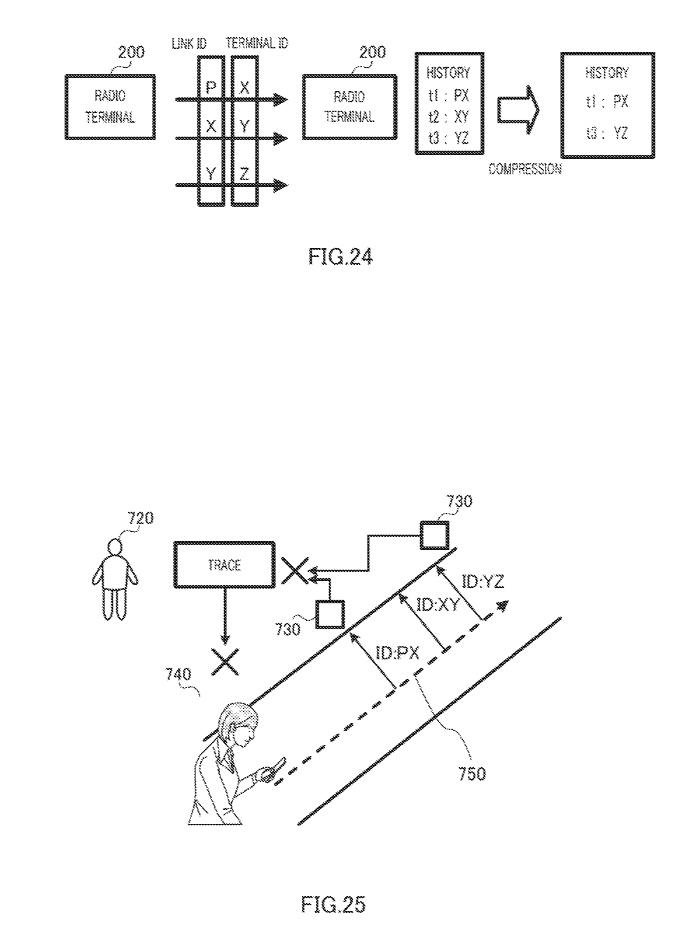

FIG. 24 and FIG. 25 are drawings showing the possibility of compressing history data and the possibility of ensuring security when ID information changes and forms a string—that is, in the case of this embodiment.

As shown in FIG. 24, transmitting-side radio terminal 200 continually broadcasts ID information that changes in a string. In this case, receiving-side radio terminal 200 can easily determine that a plurality of history data correspond to the same transmission source, and compress this plurality of history data. On the other hand, as shown in FIG. 25, malevolent third party 720 cannot find a relationship to ID information unless he performs reception continuously, making it difficult to trace an ID information transmission source.

That is to say, information collection system 100 according to this embodiment enables the security of ID information to be ensured and enables compressed recording of history data to be performed. This effect cannot be obtained by a conventional system such as described in FIG. 21 through FIG. 23.

An operation whereby radio terminal 200 transmits a communication history to base station 300 will now be described. This operation is performed by base station communication block 260 in parallel with the above-described operations of communication control block 210, radio transmission block 220, radio reception block 230, and recording medium management block 240 (see FIG. 4).

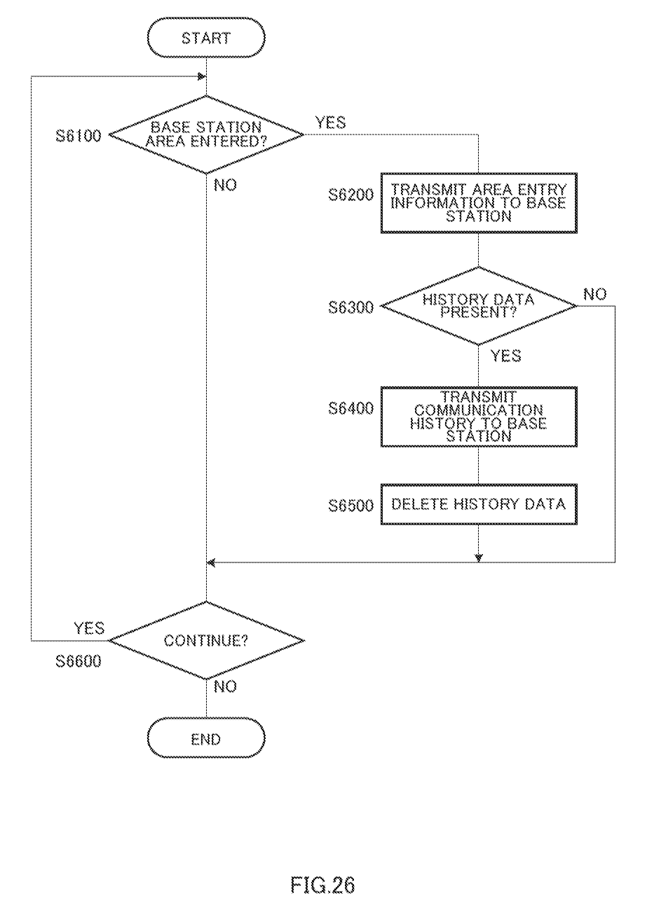

FIG. 26 is a flowchart showing radio terminal 200 operation relating to communication history transmission.

First, in step S6100, base station communication section 261 determines whether or not radio terminal 200 has entered a base station area. Whether or not a base station area has been entered can be determined by whether or not an above-described predetermined signal has been received. If radio terminal 200 has entered a base station area, and a predetermined signal has been received from base station 300 (S6100: YES), base station communication section 261 proceeds to step S6200.

In step S6200, base station communication section 261 transmits the unique ID of radio terminal 200 to base station 300 as information indicating that radio terminal 200 has entered a base station area (hereinafter referred to as “area entry information”).

Then, in step S6300, base station communication section 261 determines whether or not history data is present in storage section 250. If history data is present (S6300: YES), base station communication section 261 proceeds to step S6400.

In step S6400, base station communication section 261 transmits area entry information to base station 300 each time a base station area is entered. Also, each time a base station area is entered, base station communication section 261 reads history data stored in history data storage section 250. Then base station communication section 261 transmits a communication history in which the fixed terminal ID of radio terminal 200 has been added to the read history data to base station 300. Following this, base station communication section 261 calls history data deletion section 262.

In step S6500, called history data deletion section 262 deletes all the history data stored in history data storage section 250, and proceeds to step S6600. The processing flow also proceeds to step S6600 if radio terminal 200 has not entered a base station area (S6100: NO), or if no history data is present in history data storage section 250 (S6300: NO).

In step S6600, base station communication section 261 determines whether or not operation relating to communication history transmission is to be continued. If communication history transmission operation is to be continued (S6600: YES), base station communication section 261 returns to step S6100. On the other hand, if communication history transmission operation is not to be continued (S6600: NO), base station communication section 261 terminates the series of operations.

By means of such operation, in the event of entering a base station area, radio terminal 200 can transmit stored history data and its own fixed terminal ID to base station 300. Also, radio terminal 200 can delete uploaded history data from history data storage section 250, and secure vacant capacity for performing storage of new history data.

Each base station 300 transmits area entry information and a communication history received from radio terminal 200 to server 400 together with its base station ID. At this time, as a result, a communication history and area entry information associated with a base station ID, and radio terminal 200, are collected in server 400 via base station 300.

The configuration and operation of server 400 will now be described.

Server 400 acquires information combining area entry information and a base station ID as information regarding which radio terminal 200 entered the base station area of which base station 300 when.

Also, server 400 acquires, from a communication history, information regarding which radio terminal 200 was close to which radio terminal 200 in which segment.

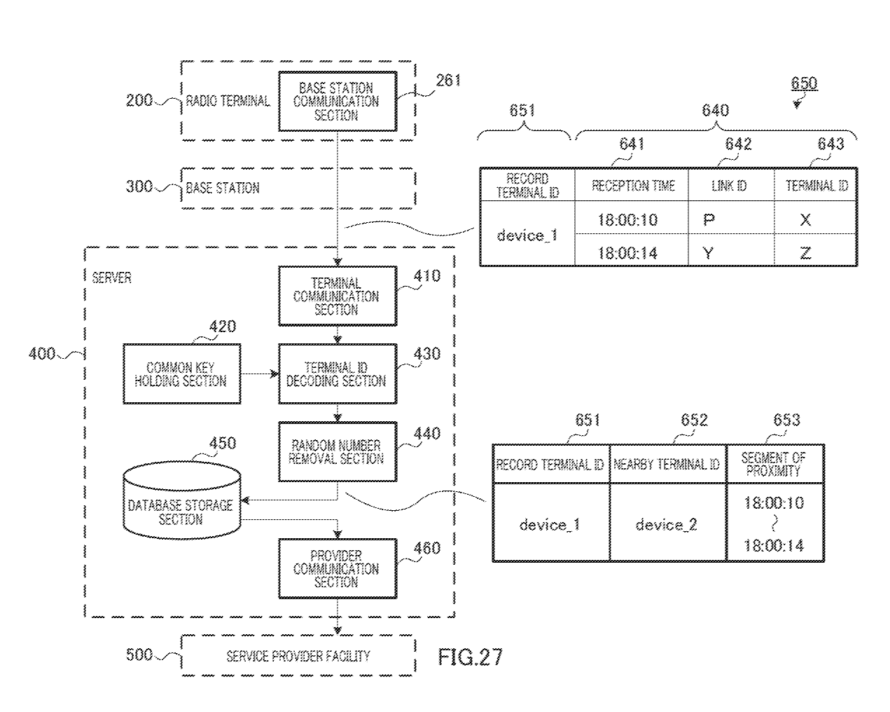

FIG. 27 is a drawing showing an overview of the configuration of server 400 and processing for a communication history. Here, a case is described in which a terminal ID is generated in radio terminal 200 by means of the method using a random number and common key shown in FIG. 7.

In FIG. 27, server 400 has terminal communication section 410, common key holding section 420, terminal ID decoding section 430, random number removal section 440, database storage section 450, and provider communication section 460.

As shown in FIG. 27, in server 400, terminal communication section 410 first receives communication history 650 from base station communication section 261 of radio terminal 200 via base station 300. Then terminal communication section 410 outputs received communication history 650 to terminal ID decoding section 430.

Common key holding section 420 holds beforehand a common key that is the same as the above-described common key held by radio terminal 200.

Terminal ID decoding section 430 extracts a fixed terminal ID of record terminal 200r from communication history 650 input from terminal communication section 410. Here, record terminal 200r denotes a radio terminal 200 that is the communication history 650 transmission source and has performed history data recording. A fixed terminal ID of record terminal 200r is also referred to below as a “record terminal ID.” Terminal ID decoding section 430 then extracts history data 640 from received communication history 650.

Then terminal ID decoding section 430 acquires a common key held by common key holding section 420. Terminal ID decoding section 430 then decodes link ID 643 or terminal ID 644 included in extracted history data 640 (see FIG. 16 and FIG. 17) using the acquired common key. Also, terminal ID decoding section 430 extracts a segment of proximity between record terminal 200r and nearby terminal 200e.

Then terminal ID decoding section 430 outputs the extracted record terminal ID and segment of proximity, and the decoded ID information, to random number removal section 440.

Random number removal section 440 extracts the fixed terminal ID of nearby terminal 200e from ID information input by terminal ID decoding section 430. Here, nearby terminal 200e denotes radio terminal 200 corresponding to history data 640. Below, the fixed terminal ID of nearby terminal 200e is also referred to as a “nearby terminal ID.”

Specifically, random number removal section 440 extracts a nearby terminal ID by executing separation processing for a fixed terminal ID and random number with contents opposite to those of the above-described combining processing for a fixed terminal ID and random number executed by radio terminal 200. Since link ID 642′ and terminal ID 643 are both data encrypted by combining a random number and fixed terminal ID as already explained, random number removal section 440 can reconstitute a fixed terminal ID from either.

Then random number removal section 440 combines input record terminal ID 651, extracted nearby terminal ID 652, and input segment of proximity 653, and stores the result in database storage section 450.

Provider communication section 460 generates a movement history for each radio terminal 200 based on information stored in database storage section 450. Then provider communication section 460 transmits a generated movement history to service provider facility 500.

By means of this kind of configuration and operation, server 400 can collect communication histories from radio terminals 200, and generate a movement history for each radio terminal 200 from the collected communication histories.

The method of extracting a record terminal ID, nearby terminal ID, and segment of proximity from a communication history corresponds to the secure ID generation method and communication history generation method in radio terminal 200. Therefore, for example, if random number incorporation is not performed on the radio terminal 200 side, random number removal section 440 is not necessary in server 400. Service provider facility 500 performs user-specific movement estimation and so forth based on a movement history of each radio terminal 200 received from server 400.

A communication history may take a different form according to the use of movement estimation results and/or the precision required for movement estimation. In this case, it is necessary for radio terminal 200 to perform history data compression using a method different from that shown in FIG. 19, by means of processing different from the recording medium management processing shown in FIG. 18.

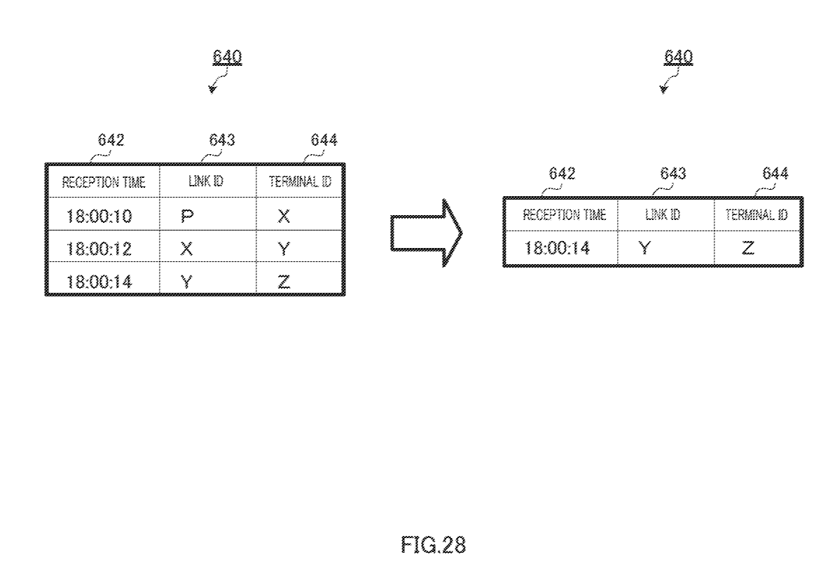

FIG. 28 through FIG. 30 are drawings showing examples of other history data compression methods.

As shown in FIG. 28, compression processing section 243 may, for example, delete history data 640 other than history data 640 for which the time is latest among history data 640 in which ID information forms a string. This is suitable for a case in which only the time at which proximity to another radio terminal 200 ends is necessary as a movement history outside a base station area.

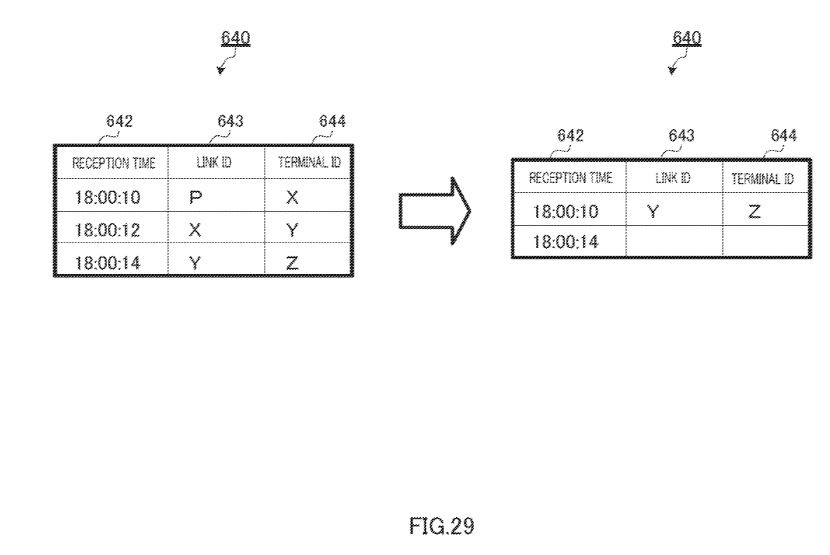

Also, as shown in FIG. 29, compression processing section 243 may, for example, delete intermediate history data 640 and also delete link ID 643 and terminal ID 644 of history data 640 other than the latest history data 640.

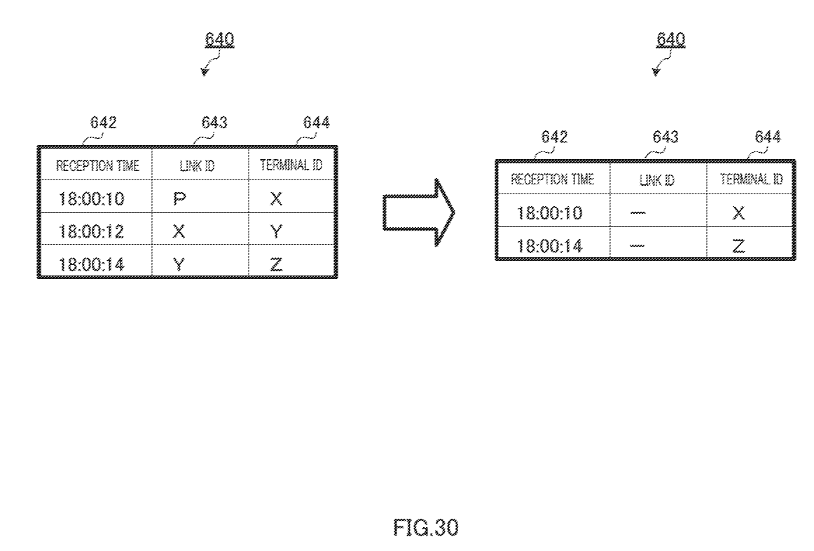

Furthermore, as shown in FIG. 30, compression processing section 243 may, for example, delete intermediate history data 640 and also delete link ID 643. Moreover, compression processing section 243 may also delete terminal ID 644 of history data 640 other than the latest history data 640.

As described above, radio terminal 200 according to this embodiment provides variability to ID information broadcast in a surrounding area, enabling the security of ID information to be ensured.

If each radio terminal 200 increases the frequency of ID information broadcasting, for example, it is possible to improve the precision of movement estimation. However, if very frequent broadcasting of the same ID information were to be continued, the possibility of tracing a user's movements would be increased. Also, the frequency of ID information of each radio terminal 200 would also increase, and if history data were held without modification there would be a possibility of overflow occurring. Therefore, radio terminal 200 that varies ID information in a compressible state can achieve both an improvement in security and an improvement in the precision of movement estimation, which has previously been difficult.

Radio terminal 200 forms ID information into a string by making a first part of ID information that is broadcast first and a second part of ID information that is broadcast thereafter the same. By this means, receiving-side radio terminal 200 can easily identify ID information whose transmission source is the same, and perform compressed recording of ID information history data. Also, radio terminal 200 can reduce the recording medium capacity necessary for history data recording, and record history data for a longer period. This also enables more detailed movement estimation to be performed.

Radio terminal 200 writes a terminal ID and link ID generated based on a fixed terminal ID in the above first part and second part respectively. By this means, receiving-side radio terminal 200 can create history data that includes a fixed terminal ID, and upload this to server 400.

Radio terminal 200 generates a terminal ID and link ID by encrypting a fixed terminal ID, enabling the security of ID information to be improved.

The method whereby radio terminal 200 handles history data 640 collectively for each transmission source is not limited to the above-described method. As another method, for example, when storing new history data 640, history data 640 may detect history data 640 that includes terminal ID 644 identical to the link ID thereof. Then history data recording section 241 may link detected history data 640 and newly stored history data 640 as history data 640 acquired from the same transmission source by assigning a corresponding ID to a slot number. In this case, if there is a terminal ID identical to a link ID, history data recording section 241 issues a new ID and assigns this to new history data 640. Also, if there is a terminal ID identical to a link ID, history data recording section 241 can acquire an ID linked to that terminal ID, and assign the acquired ID to new history data 640. By using such a mode, radio terminal 200 can specify a series of history data correctly and handle that history data collectively even if secure IDs are received from a plurality of other radio terminals 200 using the same time slot number.

The terminal ID generation method is not limited to the method described in this embodiment. For example, the terminal ID generation method may be to use a pseudo-random number value generated using a hash chain method (see Patent Literature 1, for example) as a terminal ID.

Provision may also be made for a radio terminal to decide an ID information transmission segment and reception segment randomly rather than based on a time slot management table. In this case, it is desirable to perform carrier sensing and decide a transmission segment so as not to be overlapped by a transmission segment of another radio terminal. By this means, a time slot management table can be made unnecessary.

The present invention is not limited to application to radio tags, and can be applied to various kinds of radio terminals capable of communication with another radio terminal 200. Examples include radio terminals using a WiFi (registered trademark) or Bluetooth (registered trademark) radio communication method.

The present invention can be deployed in various services other than a child monitoring service, such as a concierge service or disaster victim detection service, for example.

The disclosure of Japanese Patent Application No. 2009-158697, filed on Jul. 3, 2009, including the specification, drawings and abstract, is incorporated herein by reference in its entirety.

### INDUSTRIAL APPLICABILITY

A radio terminal and information recording method according to the present invention are suitable for use as a radio terminal and information recording method that can ensure security while collecting a communication history using little memory.

### REFERENCE SIGNS LIST

100 Information collection system
200 Radio terminal
210 Communication control block
211 Communication control section
220 Radio transmission block
221 Terminal ID generation section
222 Secure ID generation section
223 Link ID holding section
224 Transmission section
230 Radio reception block
231 Reception section
232 Secure ID analysis section
240 Recording medium management block
241 History data recording section
242 Compression determination section
243 Compression processing section
250 History data storage section
260 Base station communication block
261 Base station communication section
262 History data deletion section
300 Base station
400 Server
410 Terminal communication section
420 Common key holding section
430 Terminal ID decoding section
440 Random number removal section
450 Database storage section
460 Provider communication section
500 Service provider facility

1. A radio terminal comprising:
a secure ID generation section that generates a secure ID that includes a terminal ID; and
a transmission section that broadcasts the secure ID generated by the secure ID generation section,
wherein the secure ID generation section writes the terminal ID that differs for each transmission in a first part of the secure ID, and, in a second part of the secure ID, writes the terminal ID that was written in the first part of the secure ID transmitted immediately before as a link ID.

2. The radio terminal according to claim 1, wherein the secure ID generation section encrypts the secure ID in accordance with a predetermined encryption rule.

3. A radio terminal comprising:
a reception section that receives from another radio terminal a secure ID generated by that radio terminal;
a history information storage section that records history information that is a reception history of the secure ID received by the reception section;
a compression processing section that, when a terminal ID written in a first part of a certain secure ID received by the reception section and a link ID written in a second part of another secure ID received by the reception section match, determines that a transmission source of those two secure IDs is the same, and compresses and re-records in the history information storage section the history information of a plurality of secure IDs whose transmission source has been determined to be the same; and
a base station communication section that transmits the history information recorded in the history information storage section to a base station.

4. The radio terminal according to claim 3, wherein the history information is information combining the link ID included in the secure ID and a reception time of the terminal ID.

5. The radio terminal according to claim 4, wherein the compression processing section, when a transmission source of three or more the secure IDs has been determined to be the same, records only group information whose reception time is earliest, group information whose reception time is latest or both, among corresponding group information.

6. The radio terminal according to claim 5, further comprising:
a history information recording section that records the group information of the received secure ID in the history information storage section; and
a compression determination section that determines whether or not vacant capacity of the history information storage section is less than or equal to a predetermined threshold value,
wherein the compression processing section, when vacant capacity of the history information storage section has been determined to be less than or equal to a predetermined threshold value, performs compression processing on the group information recorded in the history information storage section.

7. The radio terminal according to claim 6, further comprising:
an information output section that transmits information regarding the secure ID recorded in the history information storage section to a radio base station; and
an information deletion section that deletes the information transmitted to the radio base station by the information output section from the history information storage section.

8. An information recording method comprising the steps of:
receiving from another radio terminal a secure ID generated by that radio terminal;
recording history information that is a reception history of received the secure ID in a history information storage section;
when a terminal ID written in a first part of a certain received the secure ID and a link ID written in a second part of another received the secure ID match, determining that a transmission source of those two secure IDs is the same; and
compressing and re-recording in the history information storage section the history information of a plurality of the secure IDs whose transmission source has been determined to be the same.
